(19) United States
(12) Patent Application Publication
(10) Pub. No.: US 2002/0008098 A1
(43) Pub. Date: Jan. 24, 2002

(54) PROCESS AND DEVICE FOR THE HEAT TREATMENT OF SEMICONDUCTOR WAFERS

(76) Inventors: ALFRED BUCHNER, PISCHELSDORF (AT); THOMAS TEUSCHLER, SINGAPORE (SG); JOHANN SPERL, SIMBACH/INN (DE); THERESIA BAUER, BURGKIRCHEN (DE)

Correspondence Address: COLLARD & ROE PC, 1077 NORTHERN BOULEVARD, ROSLYN, NY, 115761696

(21) Appl. No.: 09/378,897

(22) Filed: Aug. 23, 1999

(30) Foreign Application Priority Data
Aug. 27, 1998 (DE) 198 39 092.0

(51) Int. Cl. F27D 11/00

(52) U.S. Cl. 219/390; 257/405; 219/411; 392/416; 392/418; 118/724; 118/725; 118/50.1

(57) ABSTRACT

A process for the heat treatment of semiconductor wafers, preferably monocrystalline ultrapure silicon wafers, using an upper and a lower heat source, which can be a plurality of upper and a plurality of lower lamps or banks of lamps. In the process chamber of an RTP system, the heat treatment is carried out on at least two wafers which are arranged parallel above one another, spaced apart, and are identical in terms of geometrical dimensions and thermal material properties.

### BACKGROUND OF THE INVENTION

1. Field of the Invention

The present invention relates to a process for the heat treatment of semiconductor wafers, using upper and lower heat sources in a process chamber. The present invention also relates to a device for holding the semiconductor wafers during the heat treatment.

2. The Prior Art

Semiconductor wafers are subjected to a large number of treatment processes, for example heat treatment processes. During these heat treatment processes, also known as rapid thermal processing (RTP), the semiconductor wafers are heated for a brief time, preferably for a few seconds, to temperatures preferably between 500° C. and 1200° C. Such heat treatments are used, for example, to anneal crystal defects, produce thin surface coatings or for cleaning purposes. These heat treatments are carried out in RTP reactors which are provided with controllable heat sources, for example lamps. The wafer is in this case heated by exposure to visible or infrared light in process chambers of relatively small volumes. RTP reactors therefore make it possible to change the temperature of the material very rapidly in the process chamber.

Optimum processing (rapid heating, holding step, rapid cooling) is accomplished in compact single-wafer reactors. These reactors are configured in such a way that only the material to be treated is heated. Also, large-area reactor walls or a large glass volume are not heated as well.

However, not only is a rapid heating and a rapid cooling essential for the successful processing, but also a uniform temperature distribution over the semiconductor wafers is essential for the successful processing. Also the identical heat treatment of a batch of semiconductor wafers is essential for successful processing.

Different designs of RTP reactors, for example the holding devices for semiconductor wafers or the heat sources, cause different temperature inhomogeneities, especially at the edge of the material to be treated.

It has further been found that, for example, an annular element whose internal diameter is greater than the diameter of the material in wafer form, makes it possible to compensate for increased heat loss at the edge of the wafer during the heat treatment. Structurally induced temperature inhomogeneities occur, especially, whenever the heat treatment is being carried out on wafers which have different materials or coatings in a geometrically or chemically structured form. DE 4,223,133 C2 describes the reduction of thermal inhomogeneities due to structural effects by independent control of the lamp power as well as independent control of the upper and lower banks of lamps in systems where the wafers can be heated simultaneously from above and from below.

DE 4,437,361 C2 describes a process and a device for rapid thermal treatment of sensitive components in the semiconductor industry, for example integrated circuits on semiconductor wafers. According to the process and device of DE 4,437,361, it is possible to reduce active and passive thermal inhomogeneities due to structural defects. According to DE 4,437,361, specially back-coated semiconductor wafers fitted with sensitive components are successfully heat treated by the use of a light transformer plate and a pyrometer. A disadvantage with this process is that it is possible to treat only one production wafer at a time and that the light transformer plate firstly needs to be heated. The technologically prescribed heating rate and capacity requirements for economic fabrication cannot be achieved with this process. Furthermore, each time a production wafer has been treated, the light transformer plate needs to be replaced for the next treatment of a production wafer with a different coating, a different thermal material property, or a different geometrical dimension. Each replacement of the light transformer plate likewise has a disadvantageous effect on the production wafers since contamination, for example with particles, is introduced into the process chamber.

In the prior art referred to above, different solutions are proposed for homogeneous heat treatment of semiconductor wafers as well as of sensitive components in the semiconductor industry. This type of heat treatment is restricted to the treatment of only one production wafer at a time. However, no prior art reference discloses the homogeneous heat treatment of at least two semiconductor wafers simultaneously. Preferably these two wafers are monocrystalline ultrapure silicon wafers with identical geometrical dimensions, which do not suffer from any structurally induced thermal inhomogeneities and which allow heat losses to be interactively compensated.

### SUMMARY OF THE INVENTION

It is an object of the present invention to provide a process and a device with which at least two semiconductor wafers can be subjected simultaneously to a homogeneous heat treatment and subsequently be used as production wafers.

The above object is achieved according to the invention by a process for the heat treatment of semiconductor wafers, using upper and lower heat sources in a process chamber, wherein the heat treatment is carried out on at least two wafers simultaneously which are arranged parallel one above the other, spaced apart, and are identical in terms of geometrical dimensions and thermal material properties.

The above object is also achieved according to the invention by a holding device for the heat treatment of semiconductor wafers in a process chamber, having a support frame which is fastened in the process chamber and has inwardly pointing bars with supports which permit parallel spacing. If two plates are arranged parallel above one another, spaced apart, then the wafer surfaces which face one another in the stack are shielded from the heat source by the other respective wafer. This has resulted in the prior art in an inhomogeneous temperature distribution on the individual wafer surfaces, which makes identical heat treatment of this batch of wafers unfeasible.

However, it has surprisingly been found according to the invention that two semiconductor wafers, preferably monocrystalline ultrapure silicon wafers, can be homogeneously heat treated if they are identical in terms of geometrical dimensions and thermal material properties. These wafers are heat treated in the holding device according to the invention in a process chamber while being arranged parallel above one another and spaced apart.

The process according to the invention is based on the use of energy transfer between the wafers. The wafer surfaces which face the lamps are heated by receiving radiant energy from the upper and lower lamps, referred to below as a primary energy source. The surfaces facing the other wafer in each case are heated by reflection and emission of radiant energy from the other semiconductor wafer in each case. This is referred to below as a secondary energy source. The radiant energy output is then identical since the wafers are ones that are identical in terms of thermal material properties and geometrical dimensions. The heat treatment is carried out using a primary and/or a secondary energy source.

A particular advantage found with the process according to the invention is that the capacity is increased in comparison with the prior art since due to the homogeneous heat treatment both wafers can be employed as production wafers. Since it is no longer necessary to replace light converter plates, and the holding device according to the invention is fastened in the process chamber, no contamination, for example with particles, is introduced into the process chamber.

According to a preferred embodiment, the semiconductor wafers, preferably monocrystalline ultrapure silicon wafers, are firstly transferred into the holding device according to the invention. This is then fastened into the process chamber of an RTP reactor with controllable banks of lamps or controllable lamps. The holding device can in this case be loaded with at least two monocrystalline ultrapure silicon wafers at the same time, or one after the other. The wafers are then heated by radiant energy, preferably at a heating rate of 50° C./s to 500° C./sec, to temperatures of preferably between 500° C. and 1200° C. The temperature is thereafter maintained by continued radiant energy input, preferably for 1 s to 300 sec. Finally, a cooling phase takes place preferably at −10° C./sec to −100° C./sec.

Before the heat treatment of the wafers, optimization first of all needs to be carried out, for example of the lamp power, by a series of tests. Preferably only wafers of the same generic type, preferably monocrystalline ultrapure silicon wafers, with identical thermal material properties and geometrical dimensions, are heat treated.

The homogeneous temperature distribution over the semiconductor wafers required by a person skilled in the art, as well as the identical heat treatment of a batch of semiconductor wafers of the same generic type, is achieved with the process according to the invention.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings, wherein similar reference characters denote similar elements throughout the several views:

FIG. 1 shows a graphical illustration for the temperature difference during the time of the heat treatment of wafers according to the process of the invention;

FIG. 2a shows a top view of a holding device of the invention;

FIG. 2b shows a section view of the holding device along line IIb-IIb of FIG. 2a; and

FIG. 3 shows another embodiment of the holding device of the invention in section view.

### DETAILED DESCRIPTION OF PREFERRED EMBODIMENTS

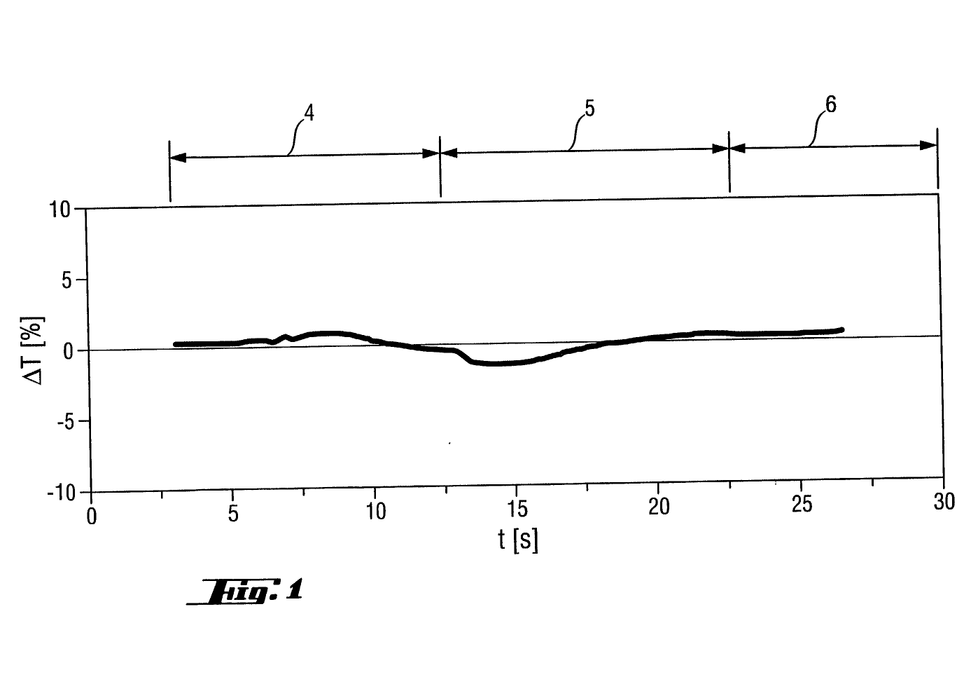

Turning now in detail to the drawings, FIG. 1 shows the heat treatment performance of the process according to the invention. Thermocouples were fitted simultaneously to two monocrystalline ultrapure silicon wafers arranged parallel above one another, and spaced apart, preferably by between 1 and 30 mm, particularly preferably between 10 and 20 mm. The wafers were then heat treated using the process according to the invention. The relative temperature difference ΔT in % in the temperature measured by the thermocouples is plotted in FIG. 1 on the ordinate; the abscissa represents the time axis t in seconds. The process according to the invention permits virtually identical heat treatment of this batch of wafers during the heating (4) step, the holding (5) step and cooling phases (6).

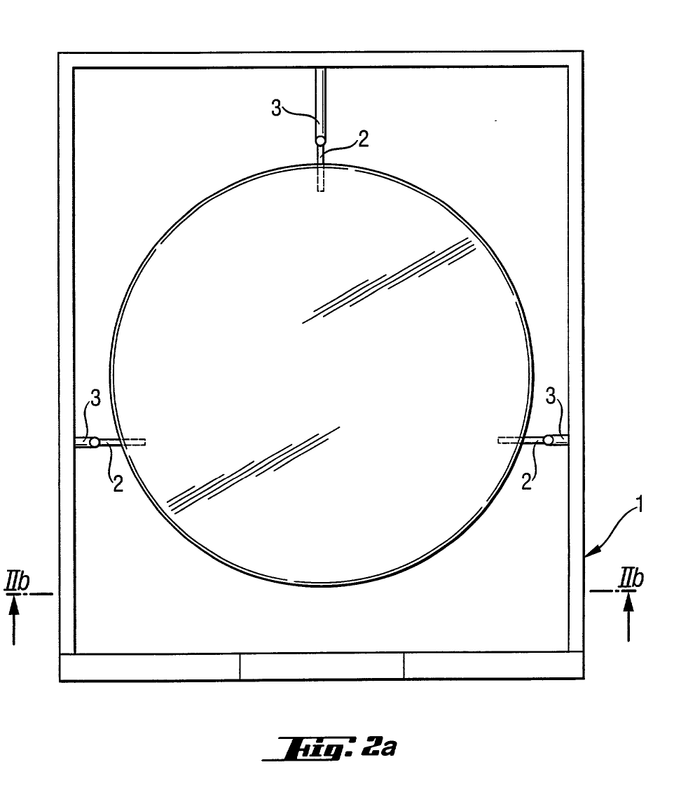

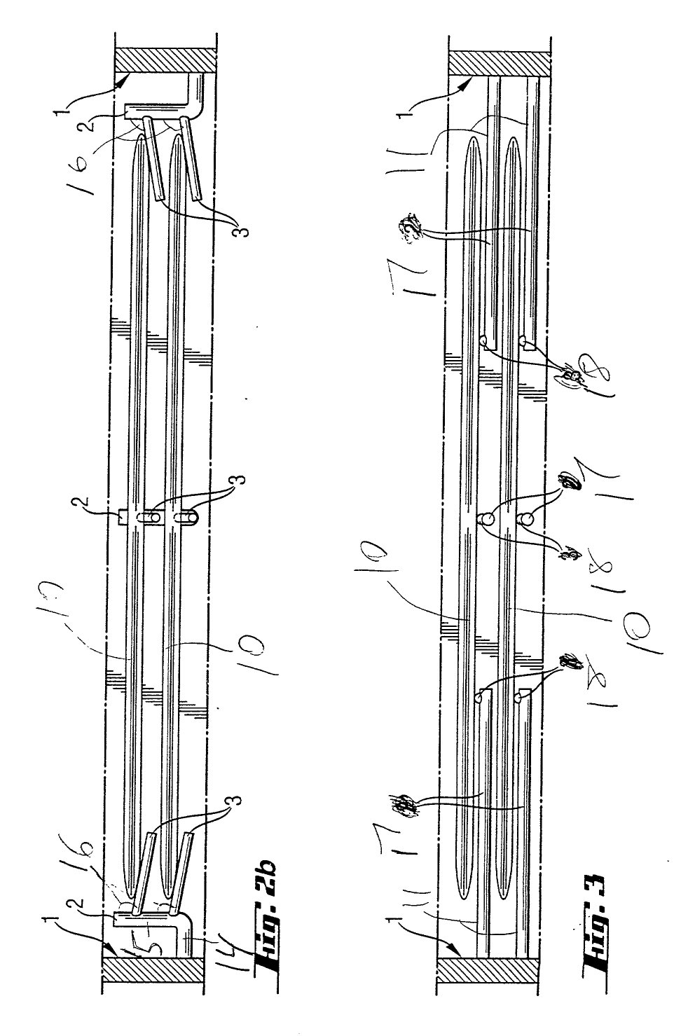

The holding device according to the invention for carrying out the process is made from a heat-resistant material that does not contaminate the wafers, for example quartz glass, aluminum oxide, silicon carbide or silicon. One preferred embodiment of the holding device is shown in FIGS. 2a and 2b, although the device according to the invention is not restricted to the shape and size of the support frame and the bars and the number of bars and supports. A further preferred embodiment of the holding device is shown in FIG. 3.

In the embodiment shown in FIGS. 2a and 2b, the holding device is composed of a support frame 1 and three inwardly pointing bars 2. Supports 3 for holding semiconductor wafers are fitted onto the bars 2. The bars 2 are L-shaped with the horizontal portion 14 connected to frame 1. Wafer supports 3 are connected at an angle 16 to the vertical portion 15. Angle 16 ranges from 110° to 160°. Supports 3 are parallel to each other and are designed in such a way that they permit parallel spacing of the semiconductor wafers. Supports 3 directly contact the wafers 10. The preferred parallel spacing has a value of between 1 and 30 mm, and the particularly preferred parallel spacing has a value of between 10 and 20 mm.

FIG. 3 shows another embodiment whereby it is possible to hold wafers with different diameters. Here the supports 17 are attached directly to the support frame 1 without any bars 2. Supports 17 are parallel to each other and do not contact the wafers 10. Instead each support 17 has a rounded projection 18 upon which wafer 10 rests. Projection 18 on the top surface 11 of support 17 contacts the wafers 10.

The holding device is preferably rigidly installed in the process chamber, in order to prevent contamination from being introduced from the outside.

Accordingly, while a few embodiments of the present invention have been shown and described, it is to be understood that many changes and modifications may be made thereunto without departing from the spirit and scope of the invention as defined in the appended claims.

What is claimed is:

1. A process for the heat treatment of semiconductor wafers, comprising
arranging at least two semiconductor wafers parallel above one another, spaced apart in a process chamber, said wafers being identical in geometrical dimensions and thermal material properties; and
heat treating simultaneously said at least two semiconductor wafers by using an upper heat source and a lower heat source in said process chamber for said heat treating.

2. The process as claimed in claim 1,
wherein the wafers are spaced apart by between 1 mm and 30 mm.

3. The process as claimed in claim 1, comprising
carrying out the heat treating using a primary energy source and a secondary energy source.

4. A holding device for the heat treatment of at least two semiconductor wafers simultaneously in a process chamber, comprising
a support frame (1) which is fastened in the process chamber and said support frame has inwardly pointing bars (2) with at least two rows of parallel supports (3) which permit parallel spacing of said at least two wafers.

5. The holding device as claimed in claim 4,
wherein the holding device is made of a heat-resistant material that does not contaminate the semiconductor wafers.

6. A holding device for the heat treatment of at least two semiconductor wafers simultaneously in a process chamber, comprising
a support frame (1) which is fastened in the process chamber;
at least two rows of parallel supports (17) directly attached to said support frame (1); and
each support (17) having a top surface (11) on which is located a rounded projection (18), and said rounded projection (18) permitting parallel spacing of said at least two wafers.
